(19) United States
(12) Patent Application Publication
(10) Pub. No.: US 2015/0039387 A1
(43) Pub. Date: Feb. 5, 2015

(54) BUSINESS SUPPORT METHOD AND SYSTEM

(71) Applicant: Hitachi, Ltd., Tokyo (JP)

(72) Inventors: Rie AKAHOSHI, Tokyo (JP); Shigeru SUZUKI, Tokyo (JP); Hiroko ENDO, Tokyo (JP); Akira NAKAJIMA, Tokyo (JP)

(73) Assignee: Hitachi, Ltd., Tokyo (JP)

(21) Appl. No.: 14/304,446

(22) Filed: Jun. 13, 2014

(30) Foreign Application Priority Data
Jul. 30, 2013 (JP) 2013-157363

(51) Int. Cl. G06Q 30/02

(52) U.S. Cl. CPC G06Q 30/0201
USPC 705/7.29

(57) ABSTRACT

A business support method and system includes a terminal and a server. The terminal displays marketing activity data delivered from the server and acquires details of the marketing activity data; transmits to the server a calculation request including the details and obtains a calculation result when the details acquired include certain predetermined items; applies a predetermined calculation algorithm to the details to obtain a calculation result when the details do not include the predetermined items; stores the calculation result obtained at the server or the calculation result acquired at the terminal in a storage unit in association with the client's identification information; and displays the calculation result. The server receives a calculation request including the details from the terminal, applies a predetermined calculation algorithm to the details, and returns the obtained calculation result to the terminal.

### CROSS-REFERENCE TO RELATED APPLICATION

The present application claims the benefit of priority pursuant to 35 U.S.C. §119(a) to Japanese Patent Application No. 2013-157363, filed on Jul. 30, 2013, the entire disclosure of which is hereby incorporated herein by reference.

### BACKGROUND

1. Technical Field

Embodiments of this disclosure generally relate to a business support method and a business support system, and more particularly to a technology for flexibly and reliably responding to circumstances in which marketing activities take place to thereby provide effective business support. The term “marketing activities” as used in the present specification also includes non-profit operations and activities. For example, technologies supporting activities other than product purchases, such as explaining taxes, are also within the technical field of the present invention.

2. Related Art

When an explanation of work of some kind is given, the circumstances, requirements, and the like of the party to which the explanation is given need to be understood. For example, during client-directed marketing activities by sales staff of a financial institution or the like, products matching the attributes and needs of the client need to be proposed and contract and sales procedures need to be correctly performed upon detailed explanation of the products in conformity with the law. Conventionally, various technologies have been proposed for the purpose of smoothly performing such jobs and improving work efficiency.

To be specific, there has been proposed, for example, a system including a business information distribution unit that delivers business information relating to marketing activities to the business channels that become a plurality of contact points between the clients and to an external activity means, a business result information collection unit that collates as business result information from the plurality of channels or the external activity means client reactions including transaction results based on the business information and newly acquired client information, an information management unit that stores business result information collated at the business results information collection unit, and an information analysis unit that analyzes business result information stored in the information management unit, creates new business information based on the analysis result, and provides the business information to the business information distribution unit (JP-2004-164205-A).

Meanwhile, since the needs of a client are not necessarily unchanging, there is a need to carry brochures used for explaining the wide variety of products, estimates of various pattern types and the like to the client's place for marketing activities according to such client's needs. Additionally, during marketing activities using brochures and the like, it is very difficult to manage without fail the history of and progress made on business discussions on various kinds of products for each client, and there is a strong concern such activities would impose excessive burdens on the sales staff. Further, details of business discussions between the sales staff and the client on the day of the sales discussion are not shared days after the sales discussion, and an effective discussion for an agreement leading ultimate to a closing is not implemented.

On the other hand, even when the aforementioned brochures and the like are computerized and stored in information processing terminals to be carried to the client's place of business for providing product descriptions and the like, there is a fear that business opportunities would be lost since dynamic processes such as simulation of advantages and disadvantages or cost estimates depending on various conditions are not performed promptly for the products listed in the brochures at the site.

It is therefore an objective of the present invention to provide a technology for flexibly and reliably responding to circumstances in which marketing activities take place to thereby provide effective business support.

### SUMMARY

Disclosed embodiments describe a business support method implemented by a computer system including a server that provides various marketing activity data and a terminal that processes the marketing activity data obtained from the server to be provided to a sales staff or a client, including the terminal displaying on an output unit the marketing activity data delivered from the server and acquiring at an input unit details of the marketing activity data, transmitting to the server a calculation request including the details and obtaining a calculation result at the server when the details acquired at the input unit include certain predetermined items, and applying a predetermined calculation algorithm to the details to obtain a calculation result when the details do not include the predetermined items, and storing the calculation result obtained at the server or the calculation result acquired at the terminal in a storage unit in association with client identification information acquired at the input unit and displaying the calculation result on the output unit. The server receives a calculation request including the details from the terminal, applies a predetermined calculation algorithm to the details to obtain a calculation result, and returns the obtained calculation result to the terminal.

Further, disclosed embodiments relate to a business support system in a computer system including a server that provides various marketing activity data and a terminal that processes the marketing activity data obtained from the server to be provided to a sales staff or a client, including the terminal displaying on an output unit the marketing activity data delivered from the server and acquiring at an input unit an details of the marketing activity data, transmitting to the server a calculation request including the details and obtaining a calculation result at the server when the details acquired at the input unit includes certain predetermined items, and applying the details to a predetermined calculation algorithm to obtain a calculation result when the details does not include the predetermined items, and storing the calculation result obtained at the server or the calculation result obtained at the terminal in a storage unit in association with client identification information the acquired at the input unit and displaying the calculation result on the output unit, and the server receiving a calculation request including the details from the terminal, applying the details to a predetermined calculation algorithm to obtain a calculation result, and returning the obtained calculation result to the terminal.

According to the present invention, effective business support can be provided by flexibly and reliably responding to circumstances in which marketing activities take place.

### BRIEF DESCRIPTION OF THE DRAWINGS

For a more complete understanding of the present invention and the advantages thereof, reference is now made to the following description taken in conjunction with the accompanying drawings wherein:

FIG. 1 is a network diagram of a business support system of one embodiment of the present invention;

FIG. 2 is a diagram illustrating a configuration example of a tablet terminal;

FIG. 3 is a diagram illustrating a configuration example of a client terminal;

FIG. 4 is a diagram illustrating a configuration example of a server;

FIG. 5 is a diagram illustrating an example of a contents data management table;

FIG. 6 is a diagram illustrating an example of a contents distribution management table;

FIG. 7 is a diagram illustrating an example of a calculation module management table;

FIG. 8 is a diagram illustrating an example of a project management table;

FIG. 9 is a diagram illustrating an example of a client management table;

FIG. 10 is a diagram illustrating an example of a trial calculation table (insurance product);

FIG. 11 is a diagram illustrating an example of a trial calculation table (loan product);

FIG. 12 is a diagram illustrating an example of a tag table;

FIG. 13 is a diagram illustrating an example of an operation log management table;

FIG. 14 is a flowchart illustrating an example of a business support method; and

FIG. 15 is a diagram illustrating a screen example;

### DETAILED DESCRIPTION

### ---System Configuration---

Embodiments of the present invention are described in detail below with reference to the drawings.

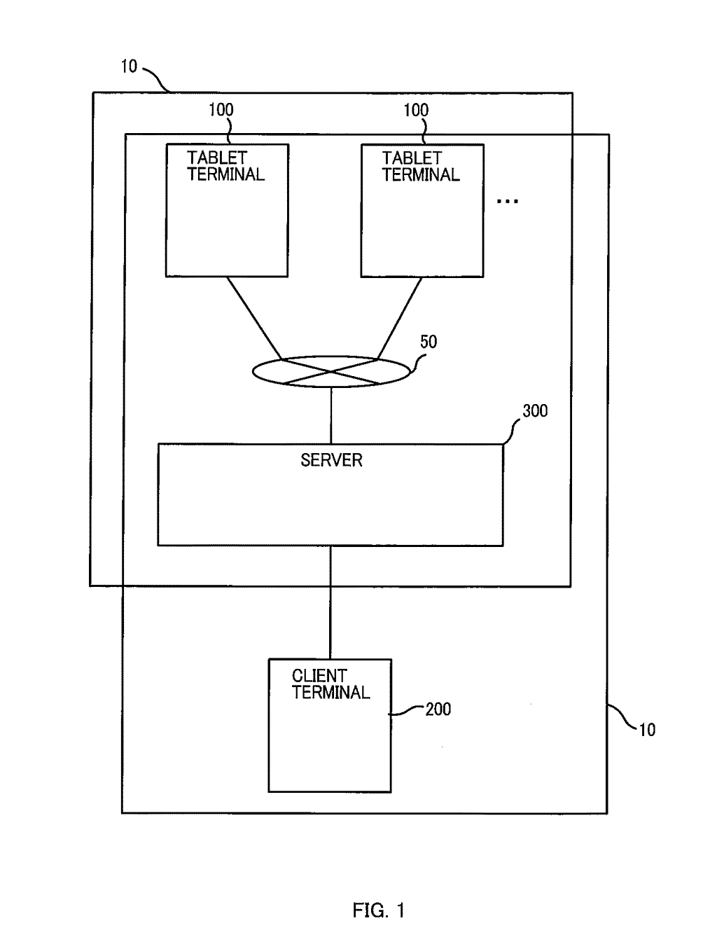

FIG. 1 is a network diagram of a business support system 10 of the present embodiment. The business support system 10 illustrated in FIG. 1 is a computer system that can flexibly and reliably respond to circumstances in which marketing activities take place to provide effective business support. The business support system 10 is configured of, for example, a tablet terminal 100 and a server 300 coupled over an Internet connection 50. The tablet terminal 100 is a terminal used by the sales staff (including the concept of a person in charge at the counter window such as a so-called teller) of a financial institution, and the server 300 is for delivering to the tablet terminal 100 contents (i.e., an electronic brochure and the like) used when describing financial products and managing data created along with marketing activities. Additionally, the Internet connection 50 is capable of being coupled to a client terminal 200 used by a client of the financial institution, and the configuration between the client terminal 200 and the server 300 is such that that allows coupling over the Internet connection 50.

The tablet terminal 100 is a terminal that acquires from the server 300 the above contents used when describing financial products and outputs the contents onto a screen of an output unit 106 such as a liquid crystal display for presentation to the sales staff and the client, and is a portable terminal used by the sales staff to bring with them to the client.

Further, the aforementioned server 300 manages contents used for describing financial products and data associated with marketing activities such as product description based on the contents using the tablet terminal 100. The above contents, such as electronic brochures and the like, are electronic data configured from screen data for supporting sales of the financial products, starting from giving an explanation of the financial product, making trial calculations and estimates on such things as the costs and investment results in accordance with the conditions laid down by the client, and up to the closing where the final contract is signed. The tablet terminal 100 allows the sales staff to reliably perform the required work procedures such as giving product descriptions and confirming the client's intentions in conformity with the law and the like, and supports effective marketing activities for product sales by outputting the contents onto the screen.

The client terminal 200 is a terminal that displays, on the screen of an output unit 206, data and the like of the history and results obtained as a result of marketing activities with the tablet terminal 100, in other words, describing financial products, making trial calculations, providing estimates and the like that are acquired by accessing the server 300. The client of the financial institution browses the details displayed on the client terminal 200 and can share an understanding of the progress of the business discussions and details of the marketing activities that the client had received.

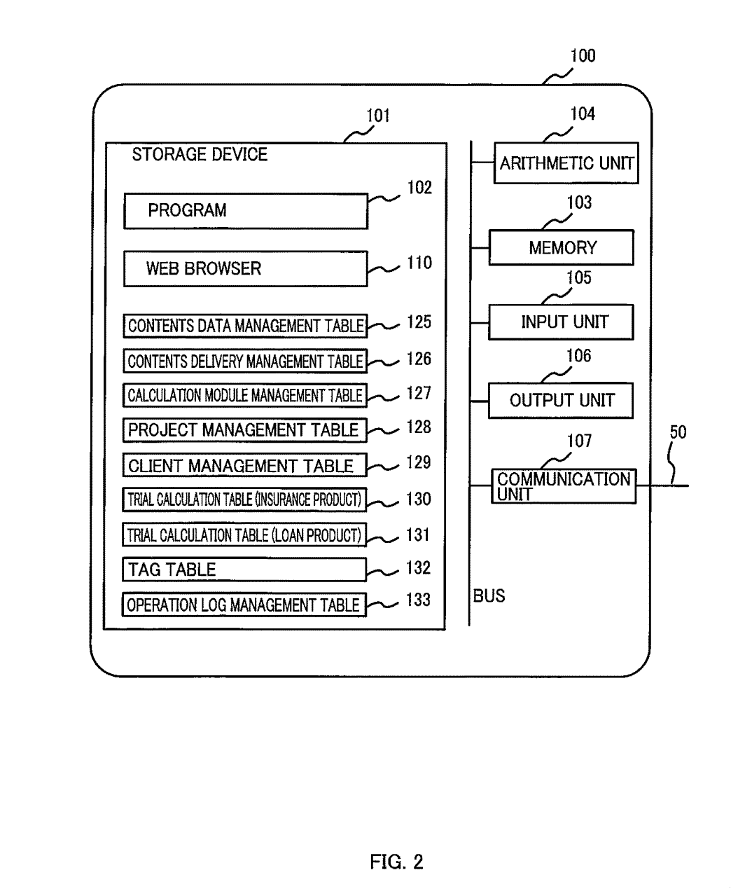

Note that, the hardware configuration of the tablet terminal 100 that configures the business support system 10 is as follows. FIG. 2 is a diagram illustrating a configuration example of the tablet terminal 100 of the present embodiment. The tablet terminal 100 includes a storage unit 101 configured with an appropriate non-volatile storage device such as a hard disk drive or a Solid State Drive (SSD), a memory 103 configured with a volatile memory device such as a RAM, an arithmetic unit 104 such as a CPU that exerts overall control of the device itself by such as reading out to the memory 103 and executing a program 102 retained in the storage unit 101 as well as performs various determinations, computations, and control processes, an input unit 105 that receives inputs and the like from touch operations by the user, a stylus, or the like, an output unit 106 of a display and the like that displays processing data, and a communication unit 107 that connects to an appropriate wide area network such as the Internet connection 50 and is responsible for communication with the server 30. Note that the storage unit 101 has stored therein at least a program 102 for implementing functions required of the terminal of the present embodiment, various tables 125 to 133, and a WEB browser 110. Description of the tables 125 to 133 is deferred.

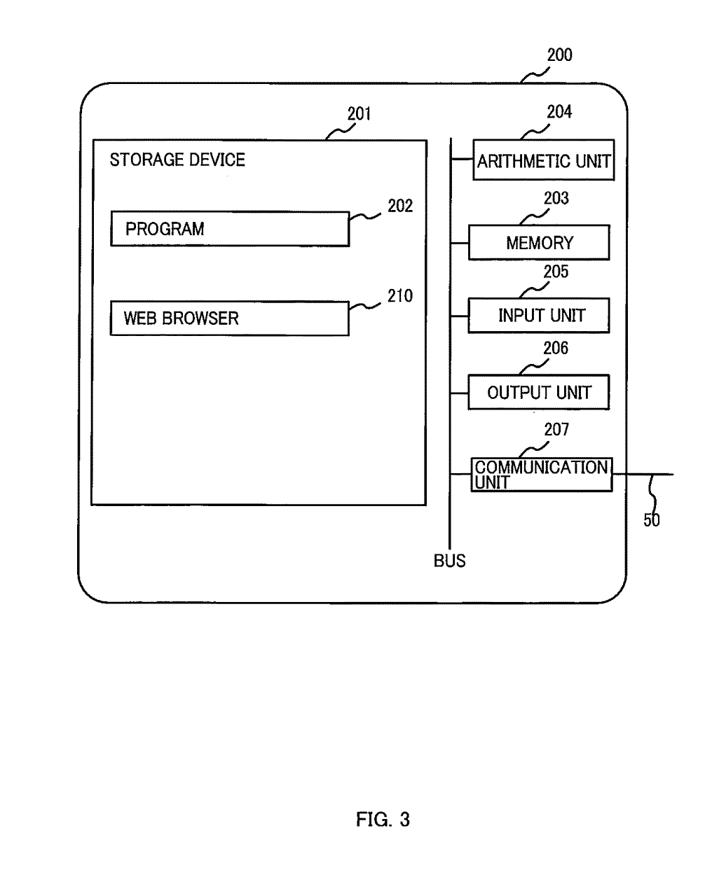

The client terminal 200 has a program configuration and a hardware configuration similar to those of an ordinary personal computer, and is communicably connectible with the server 300 through accessing the aforementioned Internet connection 50 via the WEB browser 210. Such a common configuration is as exemplified in FIG. 3 and therefore a detailed description of the hardware configuration of the client terminal 200 will be omitted.

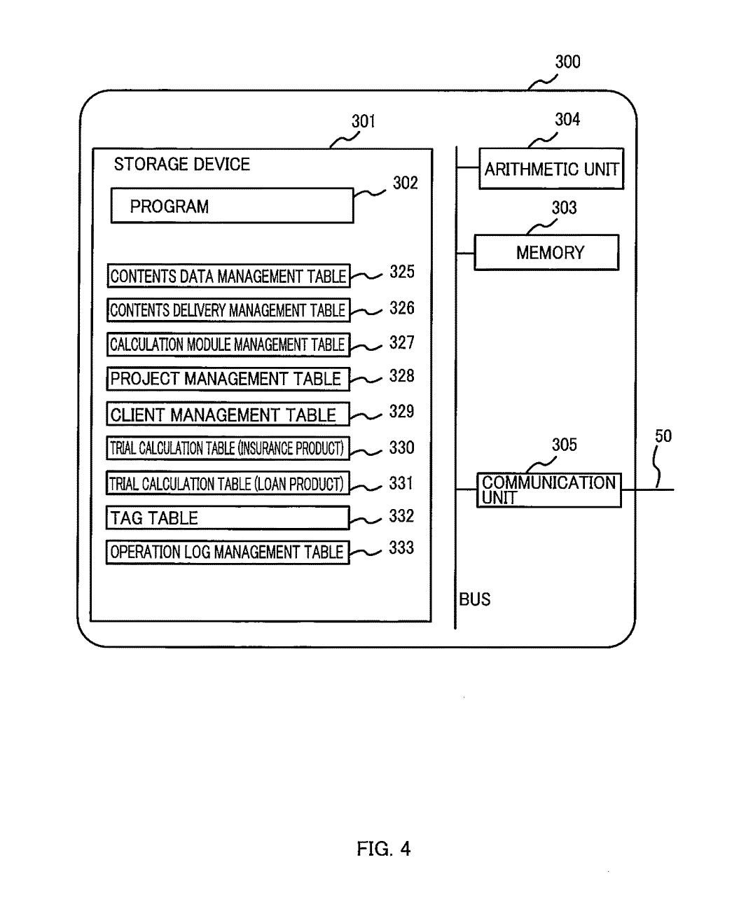

Additionally, the hardware configuration of the server 300 that configures the business support system 10 together with the tablet terminals 100 is as follows. FIG. 4 is diagram illustrating a configuration example of the server 300 of the present embodiment.

The server 300 includes a storage unit 301 configured with an appropriate non-volatile memory device such as a hard disk drive or an SSD, a memory 303 configured with a volatile memory device such as a RAM, an arithmetic unit 304 such as a CPU that exerts overall control of the device itself by such as reading out to the memory 303 and executing a program 302 retained in the storage unit 301 as well as performs various determinations, computation and control processes, and a communication unit 305 that connects to an appropriate wide area network such as the Internet connection and is responsible for communication with the aforementioned tablet terminal 100.

In addition to the program 302, the server 300 also retains in the storage unit 301 various tables 325 to 333 similar to the tablet terminal 100. Description of the tables 325 to 333 is deferred.

A description of the functions included in each of the tablet terminal 100 and the server 300 configuring the business support system 10 of the present embodiment is given below. Note that the above client terminal 200 may be included in the business support system 10 of the present embodiment.

Additionally, the functions explained hereunder can be said to be, for example, functions that are implemented by executing the programs included in the devices configuring the business support system 10.

The above tablet terminal 100 has a function of displaying on the output unit 106 data for sales activities delivered from the server 300 and acquiring at the input unit 105 the details relating to data for these sales activities. Here, the server 300 is assumed to deliver to the tablet terminal 100 screen data for giving product description divided into a plurality of frames as data for the above sales activities.

The tablet terminal 100 has a function of transmitting a calculation request including the details to the server 300 and acquiring the calculation request from the server 300 when the above details acquired at the input unit 105 include certain predetermined items. At the same time, the tablet terminal 100 also has a function of applying a predetermined calculation algorithm to the above details to obtain a calculation result when the above details do not include the predetermined items.

Further, the tablet terminal 100 has a function of storing in the storage unit 101, in association with the client's identification information acquired at the input unit 105, the calculation result obtained from the server 300 based on the above calculation request or the calculation result acquired at the tablet terminal 100, and displaying the above calculation result at the output unit 106.

In addition, the aforementioned tablet terminal 100 further has a function of storing information of the details acquired at the input unit 105 and the calculation result in the storage unit 101 in association with the client's identification information acquired at the input unit 105, and transmitting to the server 300 information stored in the storage unit 101 together with the client's identification information.

Moreover, the tablet terminal 100 further has a function of outputting to the output unit 106 information for confirming whether or not there is an intention to transmit the above calculation request to the server 300 when the details acquired at the input unit 105 include certain predetermined items and has a function of transmitting the calculation request to the server 300 when the above intention is confirmed by the sales staff or the client at the input unit 105.

As explained above, the tablet terminal 100 further has a function of displaying on the output unit 106 the above screen data used for giving product descriptions delivered from the server 300 and writes the supplementary product information input by the sales staff or the client at the input unit 105 to the tag form displayed object and displays the displayed object in a predetermined frame when the screen data, used for giving product description, divided into a plurality of frames as data for sales activities, are delivered to the tablet terminal 100 from the server 300.

In this case, the tablet terminal 100 further has a function of storing in the storage unit 101 in association with the client's identification information and together with information acquired in the manner above, the supplementary information indicated by the display object displayed in the aforementioned predetermined frame and transmits information stored in the storage unit 101 and the supplementary information to the server 300 together with the client's identification information.

On the other hand, the server 300 has a function of receiving a calculation request including the above details from the tablet terminal 100 and obtaining a calculation result by applying a predetermined calculation algorithm to the details to return the calculated result to the tablet terminal 100.

The server 300 has a function of receiving the above information and the client's identification information from the tablet terminal 100 to store in the storage unit 301 and notifying the client's client terminal 200 of the storage destination address of each piece of information.

The server 300 further has a function of receiving from the above client terminal 200 the access request specifying the above storage destination address and returning each piece of information stored at the storage destination address to the client terminal 200.

The server 300 even further has a function of receiving the aforementioned information, supplementary information, and the client's identification information from the tablet terminal 100 to store in the storage unit 301 and notifying the client's client terminal 200 of the storage destination address of the aforementioned each piece of information and supplementary information.

The server 300 even furthermore has a function of receiving the access request specifying the aforementioned storage destination address from the client terminal 200 and returning the above information and supplementary information stored at the storage destination address to the client terminal 200.

### ---Data Structure Examples---

Description of a data structure example in the tables used by the devices configuring the business support system 10 of the present embodiment will be given in the following. The tables in the following description are shared by the tablet terminals 100 and the server 300 and thus the differences will be described only when the table structures between the two differ.

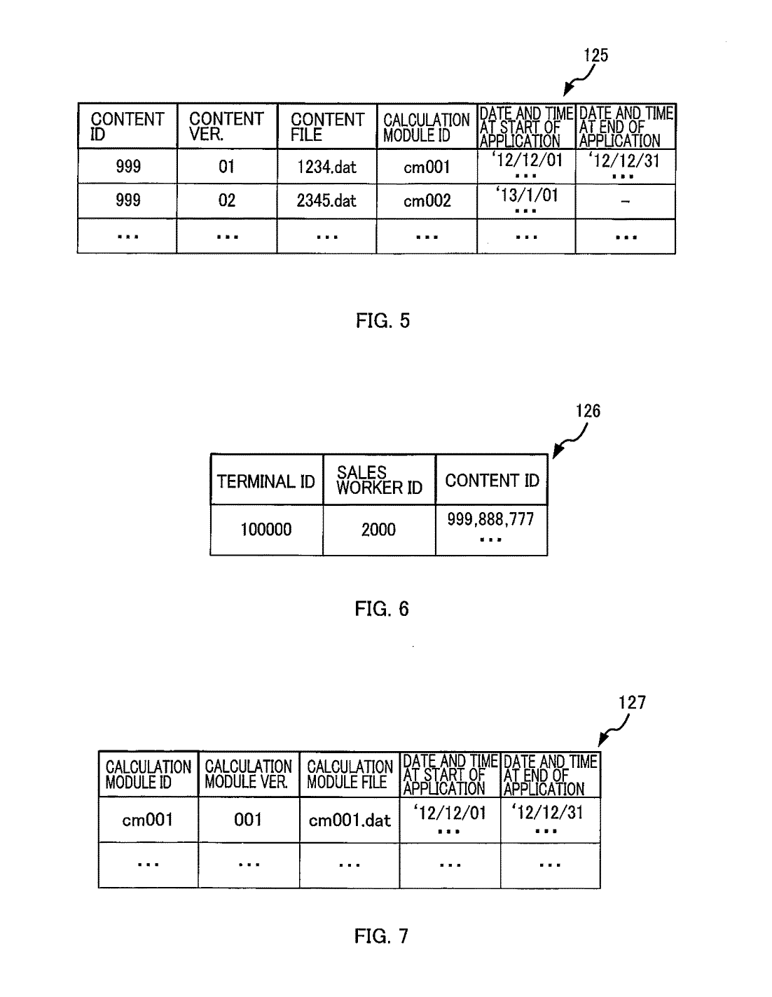

FIG. 5 is a diagram illustrating an example of the contents data management table 125 of the present embodiment. The contents data management table 125 manages contents that are data used when giving product descriptions such as electronic brochures and the like used for marketing activities and has stored therein the data of the contents distributed from the server 300 in advance before starting the marketing activities. Such a contents data management table 125 is a collection of records linked to data such as a content version indicating the version of the relevant content, a content file being the actual data of the content, calculation module ID being identification information of the calculation module used for making a trial calculation and an estimate with the contents, date and time at start of application of the calculation module, and date and time at end of application of the calculation module, using as a key the content ID that uniquely identifies the relevant content. There may be circumstances where the version numbers are incremented due to changes in the details of the products or due to changes in the law even when the contents of the financial product are the same, and as shown in FIG. 5, there may be a case where a plurality of versions exists for the same content ID. Similarly, as shown in FIG. 5, there are cases where the calculation modules applied among the versions differ so that the date and time at the start and the end of application also differ.

The contents data management table 325 in the server 300 has a data structure similar to that of the contents data management table 125 except that the number of records in the table are, as a matter of course, greater than those in the contents data management table 125 in the tablet terminal 100 since the contents data management table 325 manages all the contents distributed to the tablet terminals 100. However, detailed description thereof will be omitted since the other points in the data structure are the same as the contents data management table 125.

FIG. 6 is a diagram illustrating an example of a contents distribution management table 126 of the present embodiment. The contents distribution management table 126 manages information on contents distributed to the tablet terminal 100 from the server 300 and has a structure that associates a sales worker ID, being identification information of the sales staff using the tablet terminal 100, and the data of the content ID of the content, using as the key the terminal ID that uniquely identifies the tablet terminal 100. Note that, the contents distribution management table 326 in the server 300 also has a data structure similar to the contents distribution management table 126 except that the number of records in the table correspond to the number of tablet terminals 100 that are the destinations of the contents distribution, since the contents distribution management table 326 manages records concerning all the tablet terminals 100 that are the target of contents distribution.

FIG. 7 is a diagram illustrating an example of a calculation module management table 127 of the present embodiment. The calculation module management table 127 manages information of calculation modules that correspond to the calculation module IDs determined in the contents data management table 125, and is a collection of records linked to data such as the content version of the calculation module, calculation module file being the entity of the calculation module, and the date and time at the start and the end of the application of the calculation module, using the calculation module ID as the key.

Note that, the calculation module management table 327 in the server 300 also has a data structure similar to the calculation module management table 127 except that the number of records in the table are, as a matter of course, greater than those in the calculation module management table 127 in the tablet terminals 100 since the calculation module management table 327 manages the calculation modules concerning all the contents distributed to the tablets terminals 100.

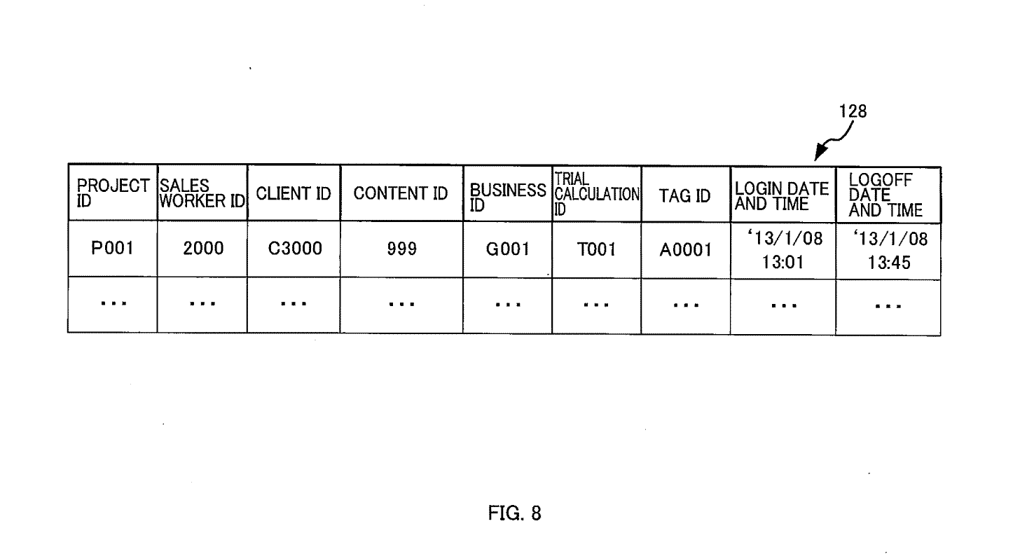

FIG. 8 is a diagram illustrating an example of the project management table 128 of the present embodiment. The project management table 128 is a collection of records linked to data such as the sales worker ID of the sales staff in charge of the project, the client ID that uniquely identifies the client, the content ID that indicates the content used, the business ID that indicates the type (i.e., insurance, loan, etc.) of financial product, the trial calculation ID being identification information of the trial calculation or the estimate made for the financial product, the tag ID used by the sales staff to identify supplementary information, and the login date and time and the logoff date and time that indicate the time and date when the business of the project had been performed, using as the key the project ID that uniquely identifies the business discussions held between the client. The project management table 128 is a table that becomes the storage destination of the details (details on the contents used when describing financial products) in the tablet terminal 100, together with the later-described trial calculation tables 130, 131, tag table 132, and the operation log management table 133.

Note that, the project management table 328 in the server 300 also has a data structure similar to the project management table 128 except that the number of records in the table are, as a matter of course, greater than those in the project management table 128 in the tablet terminals 100 since the project management table 328 manages all the projects of all the tablet terminals 100 that are the contents distribution targets.

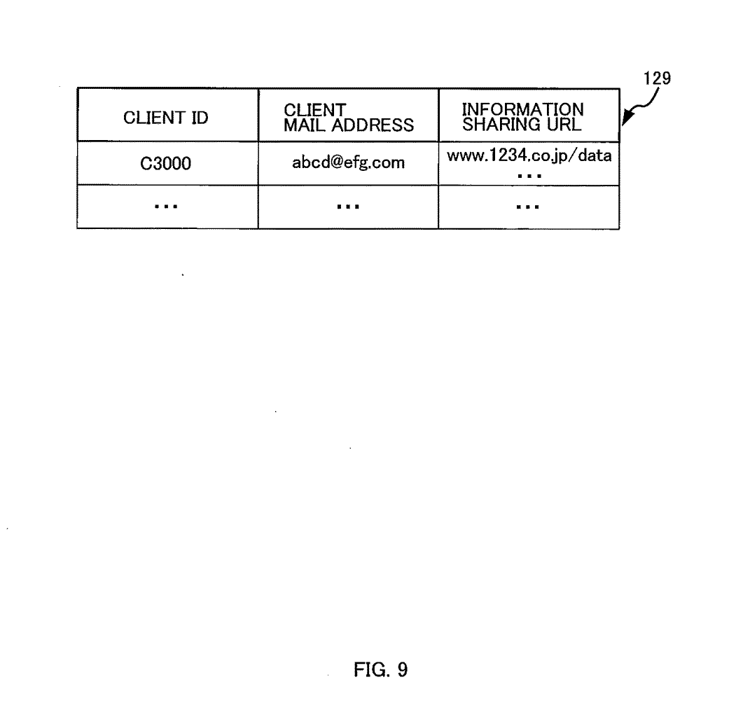

FIG. 9 is a diagram illustrating an example of a client management table 129 of the present embodiment. The client management table 129 manages information relating to clients of the sales staff responsible for the marketing activities and is a collection of records linked to data such as the client's email address and the information sharing URL using the client ID as the key. Among these, the information sharing URL is information indicating the place on the network where the information of data of such matters as the current state of the details or business discussions, trial calculations, and supplementary information relating to the content of the relevant project are disclosed to the client, and are reported to the client terminal 200 from the server 300. However, the information sharing URL is a value retained only by the client management table 329 in the server 300.

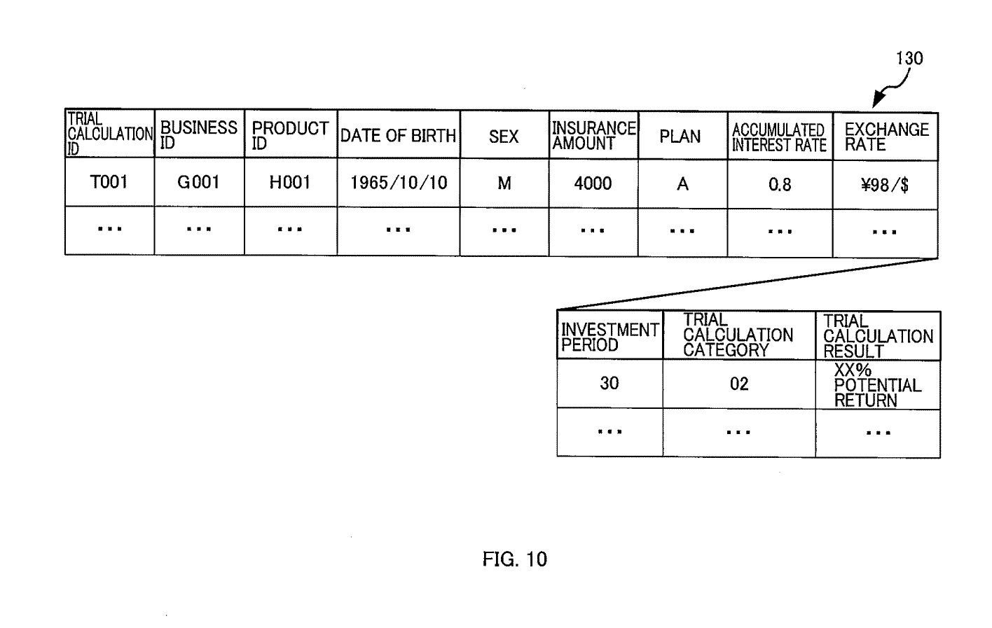

FIG. 10 is a diagram illustrating an example of a trial calculation table (insurance product) 130 of the present embodiment. The trial calculation table (insurance product) 130 is a collection of records such as the business ID, the product ID that uniquely identifies the insurance product, the date of birth and sex of the client, the insurance amount desired by the client, the plan, the accumulated interest rate, the exchange rate applied during investment, investment period of the insurance product, the trial calculation category indicating a trial calculation of a roughly-estimated level or an accurate estimate, and the trial calculation result (calculation result), using the trial calculation ID as the key. The trial calculation table (insurance product) 130 has stored therein the input value (in other words, the details, etc.) used for making the trial calculation and calculating the estimate of the insurance product and its calculation results (the calculation results obtained by applying the value of the details, etc., to the calculation module including a predetermined algorithm), corresponding to the trial calculation ID indicated in the above project management table 128.

The trial calculation table (insurance product) 330 in the server 300 has a data structure similar to that of the trial calculation table (insurance product) 130 except that the number of records in the table are, as a matter of course, greater than those in the trial calculation table (insurance product) 130 in the tablet terminal 100 since the trial calculation table (insurance product) 330 manages trial calculations of all the projects of all the tablet terminals 100.

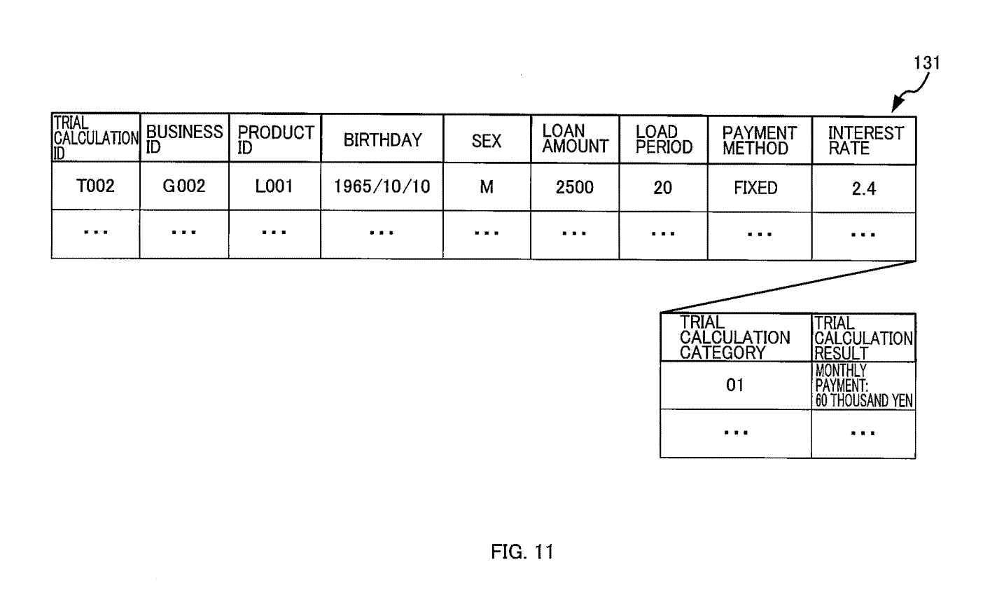

FIG. 11 is a diagram illustrating an example of the trial calculation table (loan product) 131 of the present embodiment. The trial calculation table (loan product) 131 is similar to the above trial calculation table (insurance product) 130 and has stored therein the input value (in other words, the details, etc.) used for the trial calculation and the calculation of the estimate of the loan product and its calculation results (the calculation results obtained by applying the value of the details, etc., to the calculation module including a predetermined algorithm), corresponding to the trial calculation ID indicated in the above project management table 128. The trial calculation table (loan product) 131 is a collection of records such as the business ID, the product ID, the date of birth and sex of the client, the loan amount desired by the client, the loan period, the payment method, the interest rate applied, the trial calculation category, and the trial calculation result (calculation result), using the trial calculation ID as the key.

The trial calculation table (loan product) 331 in the server 300 has a data structure similar to that of the trial calculation table (loan product) 131 except that the number of records in the table are, as a matter of course, greater than those in the trial calculation table (loan product) 131 in the tablet terminal 100 since the trial calculation table (loan product) 331 manages trial calculations of all the projects of all the tablet terminals 100.

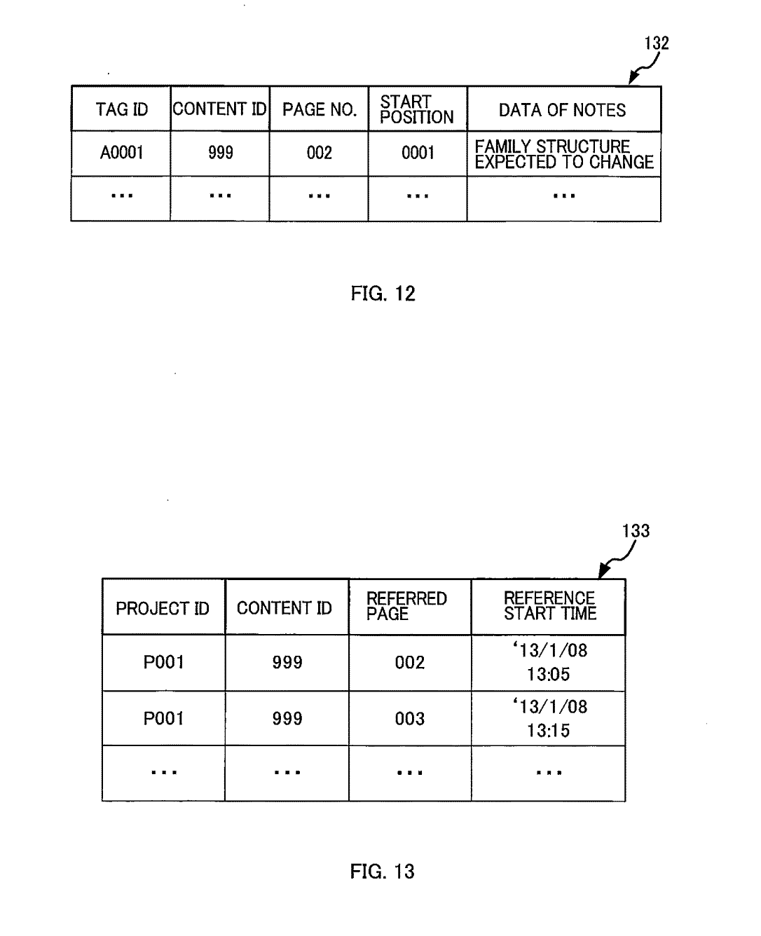

FIG. 12 is a diagram illustrating an example of a tag table 132 of the present embodiment. The tag table 132 is a collection of records linked to data such as the content ID indicating the displayed object, the page number and the start position that are the display position in the content, and data of notes that are the details of the supplementary information using as the key the tag ID that is the identification information of the tag form displayed object having the display object listed. The tag table 132 manages supplementary information relating to the financial products that is input at the tablet terminal 100 by the sales staff or the client.

The tag table 332 in the server 300 has a data structure similar to that of the tag table 132 except that the number of records in the table are, as a matter of course, greater than those in the tag table 132 in the tablet terminal 100 since the tag table 332 manages supplementary information of all the projects in all the tablet terminals 100.

FIG. 13 is a diagram illustrating an example of an operation log management table 133 of the present embodiment. The operation log management table 133 is a collection of records linked to data such as the content ID of the relevant content, the referred page in the content, and the reference start time, using as the key the project ID of the project for which the relevant content has been used. The operation log management table 133 manages the display time period during which the aforementioned content is displayed on the tablet terminal 100, in other words the operation period.

The operation log management table 333 in the server 300 has a data structure similar to that of the operation log management table 133 except that the number of records in the table are, as a matter of course, greater than those in the operation log management table 133 in the tablet terminal 100 since the operation log management table 333 manages the operation time and the like of all the projects in all the tablet terminals 100.

### ---Process Procedure Example---

In the following, description of the actual procedures followed in the business support method of the present embodiment will be given with reference to the drawings. The various operations corresponding to the business support method described below are implemented by a program, composed of code for performing various operations described below, that is read out to the memory and the like by the tablet terminal 100 and the server 300 (including the client terminal 200 in the case of the largest configuration) configuring the business support system 10.

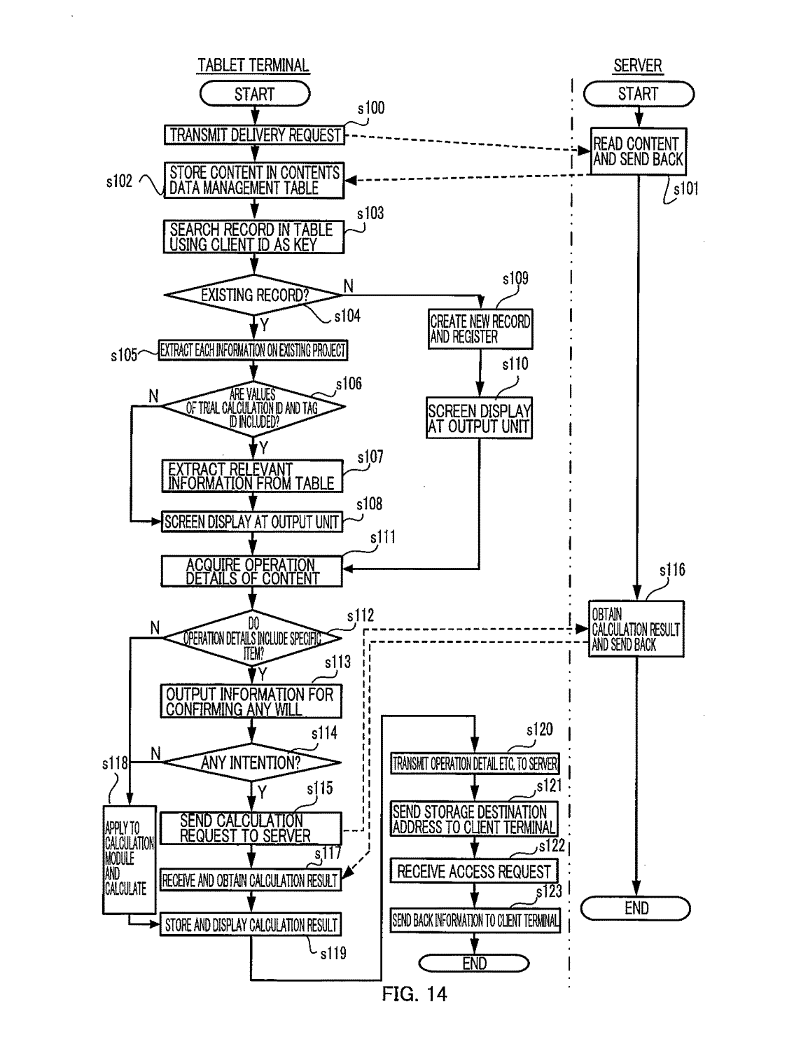

FIG. 14 is a flowchart illustrating an example of the procedures followed in the business support method of the present embodiment. First, it is assumed that the sales staff of the financial institution before going to the client's place takes the tablet terminal 100 in his/her hands and presses the distribution request button of the input unit 105 to request distribution of the content used for describing financial products. In response to the pressing of the distribution request button at the input unit 105, the arithmetic unit 104 of the tablet terminal 100 transmits the above distribution request to the server 300 via the communication unit 107 (S100). Meanwhile the server 300 that receives the distribution request reads from the content data management table 325 of the storage unit 301 the content corresponding to the attribute information indicated by the distribution request to reply to the above tablet terminal 100 (S101). During the reply process, the server 300 registers the records including the terminal ID of the tablet terminal 100, the sales person ID of the sales staff, and the content ID of the delivered content in the contents distribution management table 325 in the storage unit 301 in the server 300.

Although the content ID can be given as an example of the attribute information indicated by the distribution request, concepts such as information including identification information of the financial product, or identification information of such as the financial institution or department in which the aforementioned sales staff belongs may be included. In this case, the server 300 uses such attribute information as the key to read out the information-related content stored in the storage unit 301 which is sent back to the above tablet terminal 100. Therefore, the server 300 is assumed to retain in the contents data management table 325 of the storage unit 301 in advance various contents (i.e., electronic brochures on the financial products and the like) in association with the above attribute information.

The tablet terminal 100 that received the content delivered from the server 300 stores the relevant content in the contents data management table 125 in the storage unit 101 (S102). It is a matter of course that the data of the content delivered by the server 300 to the tablet terminal 100 also has attached a value of the items including the records of the contents data management table 325. During the content storing process, the tablet terminal 100 registers records including information of the terminal ID of its own, the sales person ID of the sales staff, and the content ID of the stored content in the contents distribution management table 126 included in its own storage unit 101.

The above sales staff will be going to meet the client for marketing activities once the sales staff has stored the necessary content in the tablet terminal 100 and finished preparing for marketing activities as described above. The sales staff that has gone to meet the client, upon starting a marketing activity, starts the predetermined application in the tablet terminal 100 and inputs the client ID of the client. An application (an existing business flow application can be used instead) that displays the above contents and sequentially executes the business flow for the financial product sales can be assumed as the predetermined application.

The tablet terminal 100 that has received the above client ID input searches the records in the project management table 128 and the operation log management table 133 using the client ID as the key (S103), and when there is an existing record (S104: YES), the information of the record, in other words, all the information (including the content, naturally) on the project of the business discussions already carried out relating to that client are extracted (S105).

When the values of the trial calculation ID and the tag ID are included in the information extracted here (S106: YES), the tablet terminal 100 extracts the information relating to the contents of the trial calculation corresponding to the trail calculation ID and supplementary information corresponding to the tag ID from the trial calculation tables 130, 131 and the tag table 132 in the storage unit 101, respectively (S107).

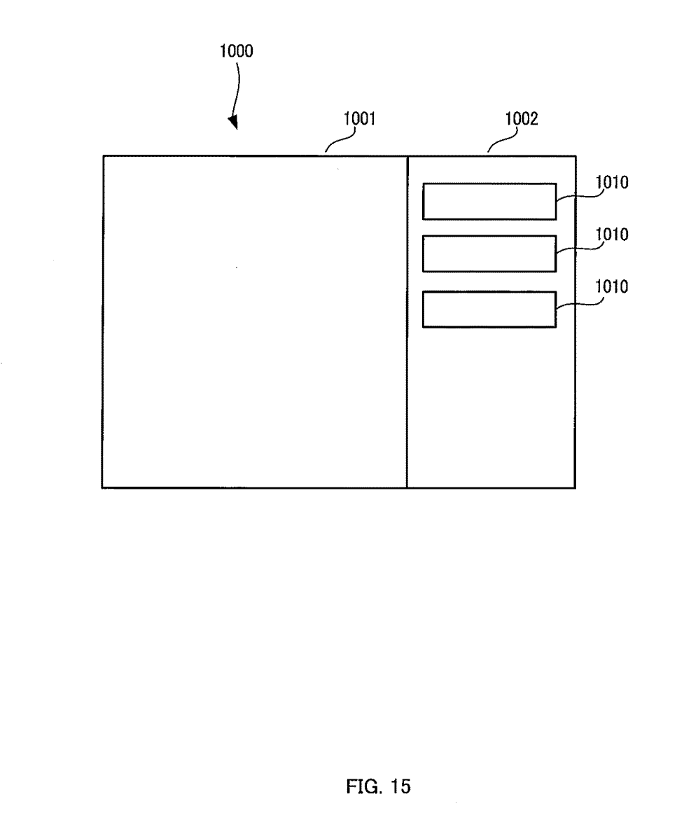

The tablet terminal 100 that has extracted information on the client up to now appropriately displays on the screen on the output unit 106 the contents and the details and calculation results corresponding thereto together with supplementary information and the like (S108). FIG. 15 illustrates an example of the display screen 1000. As shown in FIG. 15, the screen 1000 is divided into a plurality of frames 1001, 1002, and the frame 1002 displays display objects 1010 in tag form. The display object 1010 is an object that has listed therein supplementary information relating to the financial product input by the sales staff or the client at the input unit 105.

When no record is found as a result of the tablet terminal 100 searching the records in the project management table 128 and the operation log management table 133 using the client ID as the key in the above step S103 (S104: NO), the tablet terminal 100 recognizes that the a marketing activity for a new client is started and creates and registers a new record in both the project management table 128 and the operation log management table 133 (S109). In this case, the sales staff that has interviewed the new client and recognized the financial product corresponding to the client's request, reads out the contents from the contents data management table 125 for screen display on the tablet terminal 100. The tablet terminal 100 displays at the output unit 106 the content specified by the sales staff at the input unit 105 (S110). The ID (that corresponding to the content specified by the sales staff at the input unit 105) of the content corresponding to the financial product requested by the new client is set to the record in the project management table 128 by the tablet terminal 100.

Through the above process, the tablet terminal 100 displays the financial product and its content for an existing client or a new client. In this situation, the tablet terminal 100 acquires at the input unit 105 the details on the content (S111). The details which will become necessary for making a trial calculation or an estimate, or for purchasing the financial product, are values corresponding to the items composing the above trial calculation tables 130, 131, which are the date of birth and sex of the client, the investment amount, interest rate and the like, obtained through the sales staff interviewing the client and specified at the input unit 105. Further, supplementary information on the financial product added at the input unit 105 by the sales staff or the client is also included in the above details. The supplementary information is listed by the tablet terminal 100 in the tag form display object 1010 and displayed in the predetermined frame 1002 on the screen 1000. The tablet terminal 100 also adds a new record in the tag table 132 along with addition of new supplementary information. Additionally, the tablet terminal 100 sets a tag ID that is same as that of the record in the aforementioned tag table 132 in the record of the relevant project in the project management table 128.

Here, the tablet terminal 100 determines whether the details obtained at the input unit 105 as described above includes a specific item (S112). When the aforementioned details include items of, for example, the “accumulated interest rate”, the “exchange rate”, the “investment period”, the “trial calculation category: estimate” (S112: YES), the tablet terminal 100 outputs to the output unit 106 information for confirming whether or not there is an intention to transmit the calculation request including the aforementioned details to the server 300 (S113).

When the above intention is confirmed at the input unit 105 by the sales staff or the client (S114: YES), the tablet terminal 100 transmits the calculation request to the server 300 (S115). Meanwhile, the server 300 receives the above calculation request from the tablet terminal 100, applies the predetermined calculation algorithm to the values of the details included in the calculation request to obtain a calculation result, and returns the obtained calculation result to the tablet terminal 100 (S116). Then, the tablet terminal 100 receives the calculation result corresponding to the above calculation request from the server 300 (S117).

The calculation algorithm that the sever 300 applies in the process of step S116 is a calculation module that defines the contents in the contents data management table 325 and includes the current time between the start and end of application as well, and is comprised of the calculation module file of the calculation module management table 327. The calculation algorithm indicated by the calculation module file, for example, uses each value of the details as the input value and can be a polynomial used to calculate such things as the investment result of the financial product.

When, as a result of the above step S114, it is confirmed at the input unit 105 by the sales staff or the client that the above intention does not exist (S114: NO), the tablet terminal 100 advances the process to step S118.

In above step S112, when the above details do not include the predetermined items (S112: NO), or when it is confirmed at the input unit 105 by the sales staff or the client that the above intention does not exist (S114: NO), similar to the server 300, the tablet terminal 100 applies the values of the above details to the calculation module to obtain a calculation result (S118).

The tablet terminal 100 associates the calculation result acquired from the server 300 based on the above calculation request or the calculation result acquired at the tablet terminal 100 with the client's identification information acquired at the input unit 105 to create a record for storing in the trial calculation tables 130, 131 in the storage unit 101, and displays the above calculation result at the output unit 106 (S119). Here, the tablet terminal 100 creates and sets a trial calculation ID (common to both of the trial calculation tables 130, 131) in the record in the project management table 128 for projects for which calculation results are obtained in the above manner.

Meanwhile, at this time the tablet terminal 100 associates the details and the calculation results obtained at the input unit 105 with the client's identification information to transmit to the server 300 (S120). The server 300 receives each of the above pieces of information and the client's identification information transmitted from the tablet terminal 100 to store in the project management table 328 and the trial calculation tables 330, 331 in the storage unit 301 and reports the storage destination address of the information to the email address of the client terminal 200 of the client, acquired from the client management table 329 (S121).

The client terminal 200 that has received the notification of the storage destination address displays the storage destination address on the output unit 206 to be viewed by the client. When the client clicks the above storage destination address (i.e., made as a clickable hyperlink) on the client terminal 200, the client terminal 200 in response thereto activates the WEB browser 210 and transmits an access request having the storage destination address as the destination address to the server 300.

In this case, the server 300 receives the access request specifying the storage destination address from the above client terminal 200 (S122), and sends the information stored in the storage unit 301 at the storage destination address back to the client terminal 200 (S123). The client terminal 200 receives and displays the information returned from the server 300 and allows the client to view the information. Thereby the client can share the same understanding of the content and progress of the business discussions relating to himself/herself and the results of the trial calculations or estimates with the above sales staff.

Although the best mode for carrying out the invention has been specifically described hereinabove, the present invention is not to be limited thereto and can be altered in various ways without departing from the scope of the present invention.

According to the present embodiment, effective business support can be provided by flexibly and reliably responding to circumstances in which marketing activities take place.

At least the following will become apparent from the description in the present specification. In other words, in the business support method of the present embodiment, the terminal stores the details acquired and the calculation result in the storage unit in association with the client identification information obtained at the input unit and then sends the information stored in the storage unit to the server together with the client identification information. The server receives the information sent from the terminal and the client identification information for storage in the storage unit, sends the storage address of the information to the client terminal, receives from the client terminal an access request specifying the storage address, and returns to the client terminal the information stored at the storage address.

According to the above, details of the business discussions including predetermined calculation results such as various simulation results on the products can be shared between the sales staff and the client not only on the day on which the business discussion takes place but even on days thereafter, thereby enabling effective discussions for an agreement toward an ultimate closing. And such effect can be realized without imposing an excessive burden on the sales staff so that sales efficiency is also improved.

Further, according to the business support method of the present embodiment, the terminal outputs to the output unit information for confirming whether or not there is an intention to transmit the calculation request to the server when the details acquired at the input unit include the predetermined items and transmits the calculation request to the server when an intention is confirmed at the input unit

According to the above, various problems, even those of a simple case, can be quickly and appropriately handled with a terminal without executing necessary calculations on the server in circumstances such as when there is a failure on the line between the terminal and the server or when prompt action is necessary for handling the client's request and thus can improve the client's satisfaction.

Further, according to the business support method of the present embodiment, the server delivers to the terminal as the marketing activity data a product description screen data divided into a plurality of frames, and the terminal displays at the output unit the product description screen data that is delivered from the server, writes supplementary information on the product input by the sales staff or the client at the input unit to a tag form display object, displays in a predetermined frame the displayed object, stores in the storage unit in association with the client's identification information the supplementary information indicated by the display object displayed in the predetermined frame together with the acquired information, and transmits to the server together with the client's identification information the information stored in the storage unit and the supplementary information. The server receives the information as well as the supplementary information and the client's identification information from the terminal to store in the storage unit, and sends the storage destination address of the information and the supplementary information to the client terminal of the client, receives from the client terminal of the client an access request specifying the storage destination address, and returns to the client terminal the information and the supplementary information stored at the storage destination address.

According to the above, business discussions on detailed matters of variously differing products for each client can be shared between the sales staff and the client through utilizing a tag format not only on the day on which the business discussion takes place but even on days thereafter, thereby enabling further detailed and effective discussions for an agreement toward an ultimate closing.

What is claimed is:

1. A business support method implemented by a computer system including a server that provides marketing activity data and a terminal having an input unit, an output unit, and a storage unit and that processes the marketing activity data obtained from the server,
the method comprising:
the terminal
displaying on the output unit the marketing activity data delivered from the server and acquiring at the input unit details of the marketing activity data,
transmitting to the server a calculation request including the details and obtaining a calculation result at the server when the details acquired at the input unit include certain predetermined items, and applying a predetermined calculation algorithm to the details to obtain a calculation result when the details do not include the predetermined items, and
storing the calculation result obtained at the server or the calculation result acquired at the terminal in the storage unit in association with client identification information acquired at the input unit and displaying the calculation result on the output unit; and
the server
receiving a calculation request including the details from the terminal, applying a predetermined calculation algorithm to the details to obtain a calculation result, and returning the obtained calculation result to the terminal.

2. The business support method according to claim 1, wherein
the terminal
stores in the storage unit, in association with the client's identification information, information of the acquired details and the obtained calculation result acquired at the input unit and transmits to the server the information stored in the storage unit together with the client's identification information, and
the server
receives the information and the client's identification information transmitted from the terminal to store in the storage unit and sends a storage destination address of the information to a client terminal, and
receives from the client terminal an access request specifying the storage destination address, and returns to the client terminal the information stored in the storage destination address.

3. The business support method according to claim 2, wherein
the terminal outputs to the output unit information for confirming whether or not there is an intention to transmit the calculation request to the server when the details acquired at the input unit include the predetermined items and transmits the calculation request to the server when an intention is confirmed at the input unit.

4. The business support method according to claim 3, wherein
the server delivers to the terminal as the marketing activity data product description screen data divided into a plurality of frames,
the terminal
displays at the output unit the product description screen data that is delivered from the server,
writes supplementary information on the product input at the input unit to a tag form display object,
displays in a predetermined frame the displayed object,
stores in the storage unit in association with the client's identification information the supplementary information indicated by the display object displayed in the predetermined frame, together with the acquired information, and
transmits to the server together with the client's identification information the information stored in the storage unit and the supplementary information; and
the server
receives the information as well as the supplementary information and the client's identification information from the terminal to store in the storage unit, and sends the storage destination address of the information and the supplementary information to the client terminal of the client, and
receives from the client terminal an access request specifying the storage destination address, and returns to the client terminal the information and the supplementary information stored at the storage destination address.

5. A business support system comprising:
a server that provides marketing activity data; and
a terminal having an input unit, an output unit, and a storage unit, and which processes the marketing activity data obtained from the server,
wherein the terminal is configured to:
display on the output unit the marketing activity data delivered from the server and acquiring at the input unit details of the marketing activity data;
transmit to the server a calculation request including the details and obtain a calculation result at the server when the details acquired at the input unit include certain predetermined items, and apply a predetermined calculation algorithm to the details to obtain a calculation result when the details do not include the predetermined items; and
store the calculation result obtained at the server or the calculation result obtained at the terminal in the storage unit in association with client identification information acquired at the input unit and displaying the calculation result on the output unit; and
the server is configured to receive a calculation request including the details from the terminal, apply a predetermined calculation algorithm to the details to obtain a calculation result, and return the obtained calculation result to the terminal.
